(19) United States
(12) Patent Application Publication
(10) Pub. No.: US 2022/0082178 A1
(43) Pub. Date: Mar. 17, 2022

(54) SENSING GATE VALVE POSITION

(71) Applicant: Patriot Research Center, LLC (DBA Atlas Pressure Control), Houston, TX (US)

(72) Inventors: Brandon Cain, Houston, TX (US); Manish Agarwal, Cypress, TX (US)

(73) Assignee: Patriot Research Center, LLC (DBA Atlas Pressure Control), Houston, TX (US)

(21) Appl. No.: 17/214,296

(22) Filed: Mar. 26, 2021

Related U.S. Application Data
(63) Continuation-in-part of application No. 17/033,346, filed on Sep. 25, 2020.
Application No. 17/033,346 is a continuation-in-part of application No. 17/019,104, filed on Sep. 11, 2020.

(51) Int. Cl. F16K 37/00; E21B 34/16

(52) U.S. Cl. CPC F16K 37/0041; E21B 34/16

(57) ABSTRACT

A sensor system to indicate whether or not the gate valve is open, closed, or at some position between. In certain instances, two sensors may be used to indicate the position of an attachment to the gate within the gate valve thereby indicating whether or not the gate within the gate valve is fully opened or fully closed. In other instances, a single sensor may be utilized to indicate the position of an attachment to the gate within the gate valve such position being between and including fully opened and fully closed. Generally, a sensor which may include both an emitter and receiver, is affixed externally of the pressurized portion of the gate valve or other type of valves. The sensor system may detect disturbances in a pre-existing field such as a geomagnetic sensor detecting the earth's magnetic field, the sensor may create a field and then detect disturbances within that created field such as a magnetic sensor, or the sensor may send a pulse of energy towards the area to be sensed and then read the reflected energy. Generally, the sensor system includes a logic controller, a memory, a sensor or sensors that may or may not include emitters and receivers, and a display.

### CROSS-REFERENCE TO RELATED APPLICATIONS

This application claims priority to U.S. patent application Ser. No. 17/033,346 that was filed on Sep. 25, 2020 and U.S. patent application Ser. No. 17/019,104 that was filed on Sep. 11, 2020.

### BACKGROUND

When drilling and completing an oil and gas well one or more downhole formations containing high pressure gas and liquid may be penetrated by the drilling operation. Generally, a blowout preventer or other large bore valves are attached at the surface to the uppermost tubular or casing that is cemented within the wellbore.

Generally, these valves are gate valves. Each gate valve has a gate between a pair of seats. When the gate transits between an open and closed position a gate stem is utilized to push the gate into or out of position. When a gate is closed, pressurized fluid will push against the gate causing the gate to land on the seat on the opposite side of the pressurized fluid. On the side of the gate towards the fluid there is a gap between the seat and the gate. This gap allows pressurized fluid to flow into the clearance space provided to allow the gate to move between its open and closed positions. The pressurized fluid is generally proppant laden therefore the proppant or other debris moves with the fluid into the clearance space behind the gate. When enough proppant or debris moves into the clearance space behind the gate, the gate is no longer able to move between its open and closed positions as the clearance space provided to allow the gate to move between its open and closed positions is clogged with proppant, well debris, or other solids.

As the clearance space becomes clogged the gate may initially be able to move partially into the clearance space allowing the gate to move some amount thereby opening or closing the gate valve to some position between fully open or fully closed. While there may be some instances in which an operator desires to only partially open or close a gate valve generally a gate valve that is partially open is problematic. A gate valve that is partially open when the operator expects the valve to be fully open allows the gate to extend into the proppant stream where the abrasive particles erode the gate. An eroded gate may then be placed in the closed position while remaining partially open due to a portion part of the gate being eroded away. A gate valve that is partially open when the operator expects the valve to be fully closed may allow well pressure past the gate valve creating dangerous conditions for anyone approaching the well or near lines that may be subject to the uncontrolled wellbore pressure.

### SUMMARY

In an embodiment of the present invention one or more proximity sensors are placed adjacent to the gate valve to detect the presence or lack of the stem which directly correlates to a position of the gate. Generally, two sensors are utilized to detect the presence of the stem one sensor detects the presence of the stem at certain positions that correlate to the fully open position and while another sensor detects the absence of the stem which correlates to the fully closed position. In certain circumstances multiple sensors may be utilized to detect partial open positions for example as when the valve is 25 percent or 50 percent open. The sensors may be inductive, magnetic, geomagnetic, or ultrasound when no penetrations through the valve case are desired. If a penetration of the valve case is allowed then other sensors may also be used such as a light/infrared based sensor.

In another embodiment a position sensor or sensors may determine the relatively precise location of the stem and thus the gate within the gate valve. A sensor may be placed at the end of the stem so that the stem moves towards or away from the sensor as the gate moves between its open or closed position. A sensor placed in a position to directly observe the end of the stem is able to provide information as to whether the gate is fully open, fully closed, or any position between and is able to do so in real time. With a sensor able to provide the position of the stem, in this case by measuring the distance from the sensor to a known position on the stem the sensor is then able to provide where the gate is within the gate valves and to determine whether the gate is 0 percent open, 10, percent open, 90 percent open, fully open or other positions. An operator may utilize the position of the gate to determine whether or not the gate is worn beyond safe tolerances such as when the sensor indicates that the gate is closed but there is pressure leakage beyond the gate. Or when the valve is open to limits but the sensor may indicate that the gate is only partially open, for example 77 percent, the clearance space may be packing off with debris preventing the gate from fully opening. A flush may then be performed, preferably prior to the valve failing, to allow the gate to fully retract into the clearance space thereby preventing or minimizing further erosion of the gate by the proppant.

A position sensor may include a light/laser sensor to measure the distance from the sensor to a position on the stem. Sensors may also include mechanical sensors such as a rod sensor. The sensors may be electrical resistance, capacitance, or induction sensors. The sensor may utilize ultrasound to determine the position of the stem. Magnetic field sensors whether the magnetic field is artificial or geomagnetic or otherwise natural may also be used to determine the location of the stem.

### BRIEF DESCRIPTION OF THE DRAWINGS

FIG. 1 is a side cutaway view of a gate valve, with side sensors, in the open position.

FIG. 2 is a side cutaway view of a portion of the gate valve, with side sensors, in the open position.

FIG. 3 is a side cutaway view of a gate valve, with side sensors, in the closed position.

FIG. 4 is a side cutaway view of a portion of the gate valve, with side sensors, in the closed position.

FIG. 5 is a side cutaway view of a gate valve, with an end sensor, in the open position.

FIG. 6 is a side cutaway view of a portion of the gate valve, with an end sensor, in the open position.

FIG. 7 is a side cutaway view of a gate valve, with an end sensor, in the closed position.

FIG. 8 is a side cutaway view of a portion of the gate valve, with an end sensor, in the closed position.

FIG. 9 is a block diagram depicting the operation of the geomagnetic sensor, logic controller, memory, and display.

FIG. 10 is a block diagram depicting the operation of the induction coil, magnetic sensor, logic controller, memory, and display.

FIG. 11 is a block diagram depicting the operation of an ultrasonic transducer, a logic controller, a memory, and a display.

### DETAILED DESCRIPTION

The description that follows includes exemplary apparatus, methods, techniques, or instruction sequences that embody techniques of the inventive subject matter. However, it is understood that the described embodiments may be practiced without these specific details. When referring to the top of the device or component top is towards the surface of the well. Side is radially offset from a component but minimally longitudinally offset.

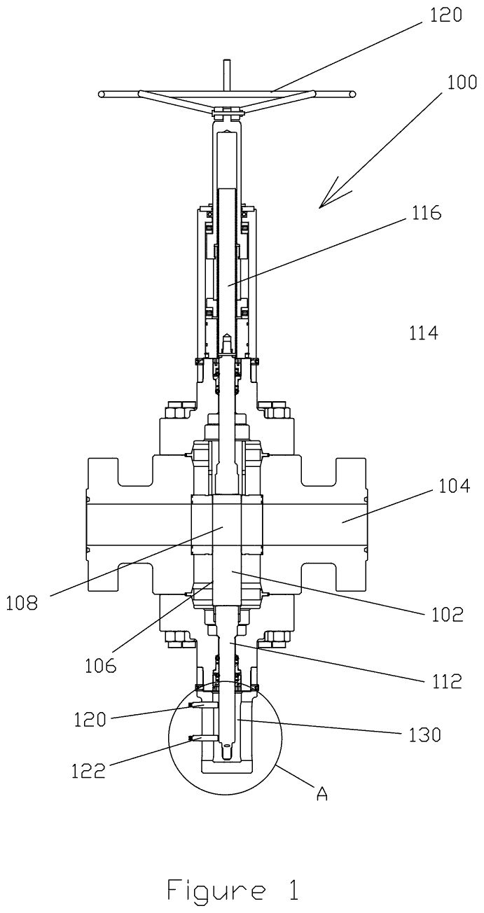

FIG. 1 is a side cutaway view of a gate valve 100. The gate valve 100 includes gate 102 and central bore 104. As depicted, the gate 102 is retracted into space 106 within gate valve 100 so that the attached gate throughbore 108 is open, providing fluid access from one side to the other of central bore 104. A 1^{st} gate stem 112 is affixed to gate 102 while a 2^{nd} gate stem 114 is attached to gate throughbore 108. Gate stem 114 is attached to rod 116. Rod 116 is driven radially inward towards central bore 104 by handle 120. In some instances handle 120 may be replaced by a powered actuating mechanism to drive gate 102 radially inward into or out of the central throughbore 104. When gate 102 is driven into central throughbore 104 fluid flow from one side to the other of central bore 104 is prevented.

With the gate 102 in the open position, as indicated, stem 112 is in its lowest position so that sensor 120 is able to detect the stem 112 within the stem bore 130 and sensor 122 is also able to detect stem 112 within the stem bore 130. When both sensors 120 and 122 detect the stem 112 within the stem bore 130 an indication is sent to the operator that gate throughbore 108 is in the fully open position within central bore 104.

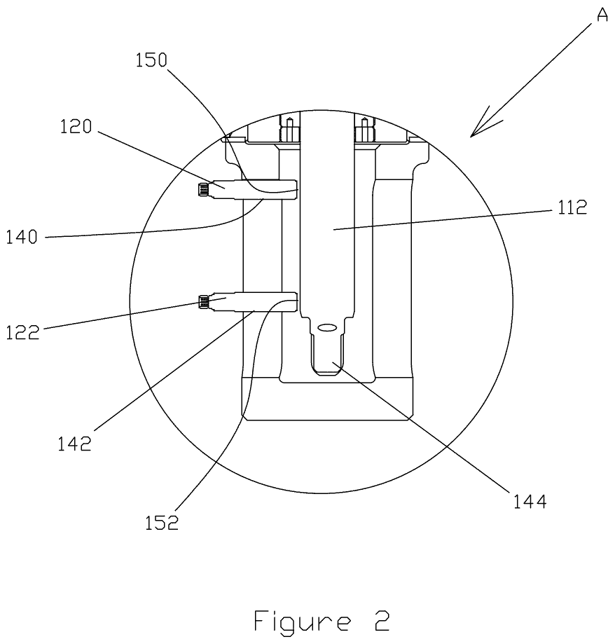

FIG. 2 is a close-up of section A from FIG. 1. The 1^{st} sensor 120 is placed within a bore 140 so that a sensor end 150 is within sensing distance of stem 112. A 2^{nd} sensor 122 is placed within a bore 142 so that a sensor end 152 is within sensing distance of stem 112. Stem 112 has a lower end 144. Sensors 122 and 120 may both detect stem 112. Each of the 1^{st} or 2^{nd} sensors 120 or 122 may be acoustic, inductive, magnetic, geomagnetic, contact, or light based.

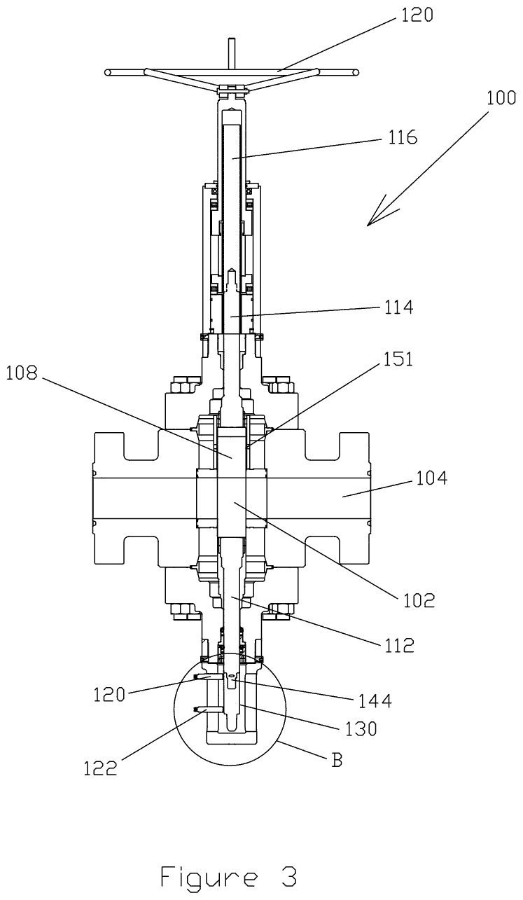

FIG. 3 depicts gate valve 100 in the closed position. Handle 120 has been actuated to move rod 116. In turn rod 116 moves 2^{nd} gate stem 114. Gate stem 114 moves gate throughbore 108 from its open position where fluid is allowed to move past gate throughbore 108 within the central bore 104 to its closed position wherein gate throughbore 108 is moved into space 151 while gate 102 is moved from space 106 into central bore 104 preventing fluid from moving past gate 102 within the central bore 104. As gate 102 moves into central bore 104 first stem 112 moves with gate 102. Stem 112 lower end 144 moves within bore 130 as the stem 112 moves within bore 130 sensor 122 no longer detects stem 112 within sensor 122's sensing distance. As the stem 112 continues to rise within bore 130 as gate 100 to moves fully into its closed position sensor 120 may, at some point, no longer detect stem 112 within sensor 120's sensing distance.

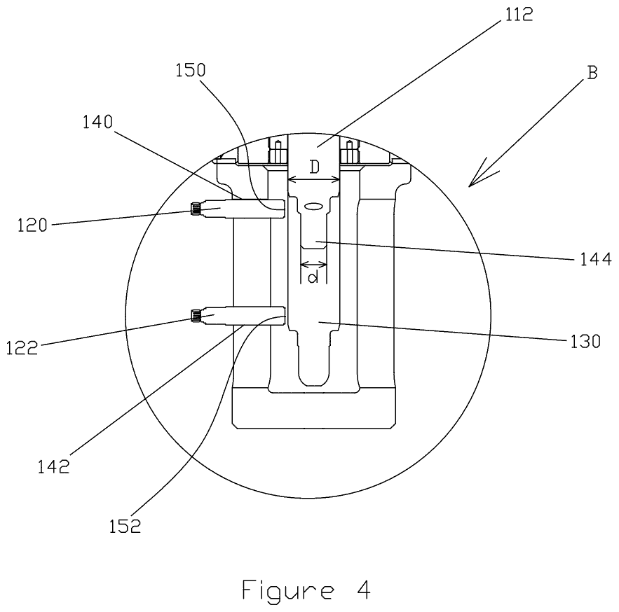

FIG. 4 is a close-up of section B from FIG. 3. The 2^{nd} sensor 122 has been adjusted such that the sensitivity of sensor 122 is no longer able to detect the stem 112 within bore 130. Sensor 120 is generally adjusted such that the sensitivity of sensor 120 is not able to detect stem 112 within bore 130. However, in some instances the sensitivity of sensor 120 may be adjusted to allow sensor 122 detect the smaller diameter d of the lower end 144 of stem 112 as compared to the larger diameter D of stem 112. Detecting the various values of diameter of the stem 112 within bore 130 may allow the operator to determine a position of the gate 102 somewhere between fully open and fully closed. Simply detecting the presence or absence of the stem within bore 130 at the locations of bore 140 and bore 142 allows the operator to turn to determine whether or not the gate 102 is fully within central bore 104 or fully retracted within bore 130.

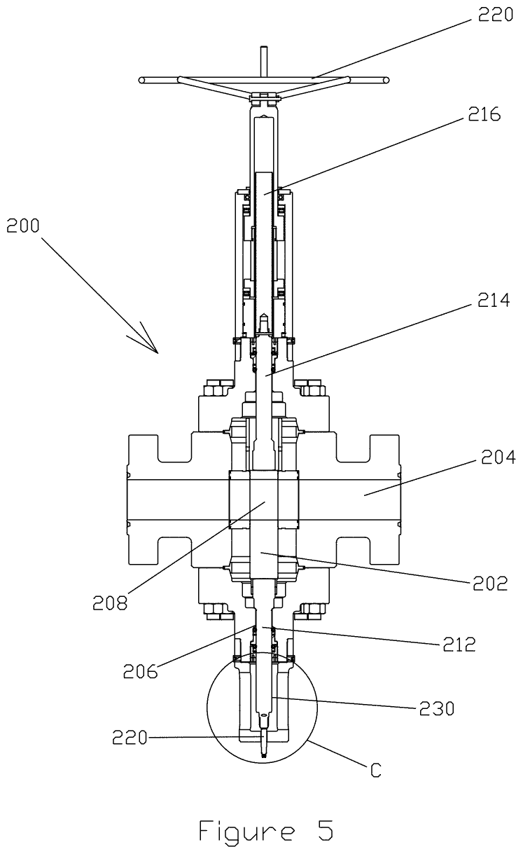

FIG. 5 is a side cutaway view of a gate valve 200. The gate valve 200 includes gate 202 and central bore 204. As depicted, the gate 202 is retracted into space 206 within gate valve 200 so that the gate throughbore 208, is in its open position, providing fluid access from one side to the other of central bore 204. A first gate stem 212 is affixed to gate 202 while a second gate stem 214 is attached to gate throughbore 208. Gate stem 214 is attached to rod 216. Rod 216 is driven radially inward towards central bore 204 by handle 220. In some instances handle 220 may be replaced by a powered actuating mechanism to drive gate 202 radially inward into or out of the central throughbore 204. When gate 202 is driven into central throughbore 204 fluid flow from one side to the other of central bore 204 is prevented.

With the gate 202 in the open position, as indicated, stem 212 is in its lowest position so that sensor 220 is able to detect the stem 212 within the stem bore 230. With sensors 220 detecting the stem 212 within the stem bore 230 an indication is sent to the operator that gate throughbore 208 is in the fully open position within central bore 204.

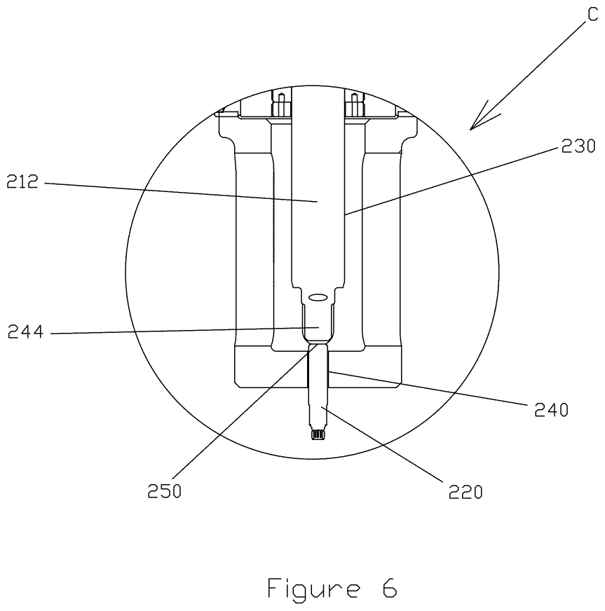

FIG. 6 is a close-up of section C from FIG. 5. The sensor 220 is placed within a bore 240 so that a sensor end 250 is within sensing distance of stem 212. Stem 212 has a lower end 244. Sensor 220 may detect stem 212. The sensor 220 may be acoustic, inductive, magnetic, geomagnetic, contact, or light based.

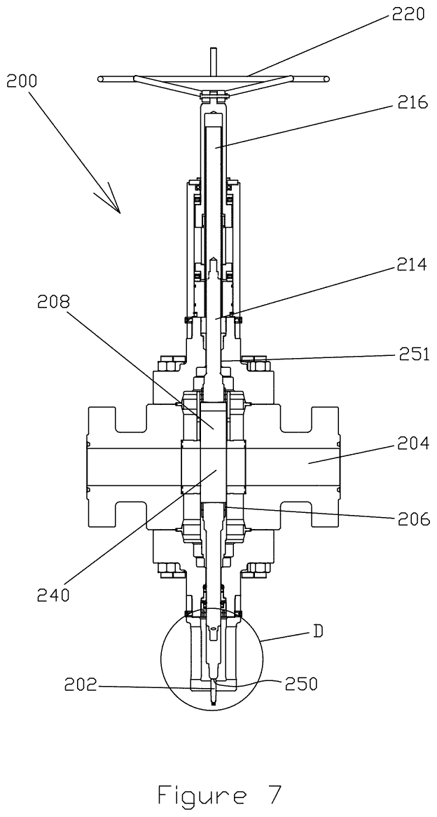

FIG. 7 depicts gate valve 200 in the closed position. Handle 220 has been actuated to move rod 216. In turn rod 216 moves second gate stem 214. Gate stem 214 moves gate throughbore 208 from its open position where fluid is allowed to move past gate throughbore 208 within the central bore 204 to its closed position wherein gate throughbore 208 is moved into space 251 while gate 202 is moved from space 206 into central bore 204 preventing fluid from moving past gate 202 within the central bore 204. As gate 202 moves into central bore 204 first stem 212 moves with gate 202. Stem 212 lower end 244 moves within bore 230. As the stem 212 moves within bore 230 sensor 220 detects a diminishing signal return indicating stem 212 has moved away from sensor 220. Sensor 220 may be calibrated to indicate the stem 221's position within bore 230. The distance of the stem 212 from the sensor 220 may be utilized as an indicator of the gate 102 and the gate throughbore 208's position between and including fully open and fully closed.

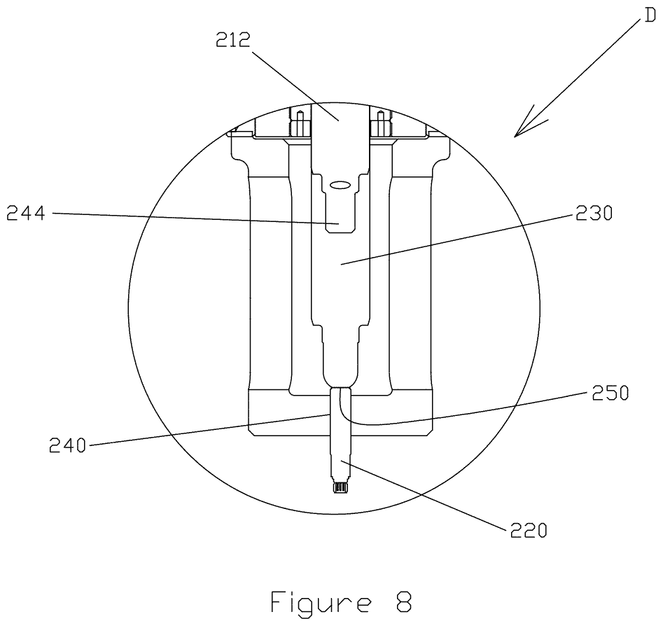

FIG. 8 is a close-up of section D from FIG. 7. The sensor 220 has been adjusted such that the sensitivity of sensor 220 is able to detect the stem 212 within bore 230 from stem 212's lowest position within bore 230, indicating that gate throughbore 208 is in position within gate bore 208 thereby placing the gate valve in the open condition. The sensitivity of sensor 220 is adjusted such that sensor 220 may also detect the stem 212 within bore 230 at stem 212's highest position within bore 230, indicating that gate 202 is in position within gate bore 208 thereby placing the gate valve in the closed condition. Detecting the various values of sensor sensitivity of sensor 220 may allow the operator to determine a position of the gate 202 including and somewhere between fully open and fully closed.

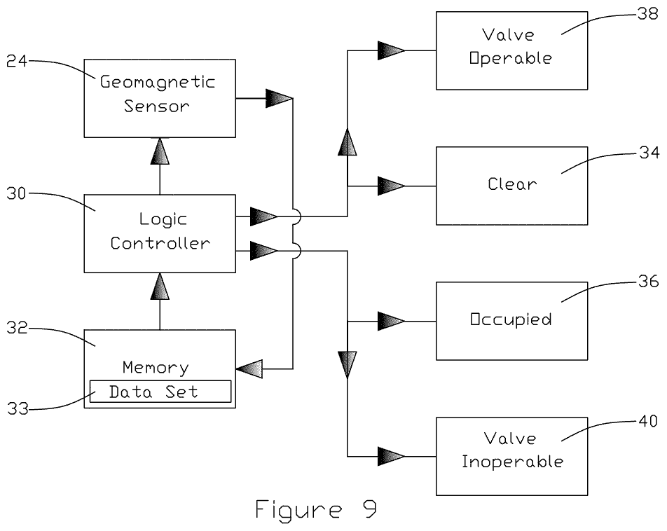

FIG. 9 is a block diagram depicting the operation of a geomagnetic sensor, logic controller, memory, and display. The geomagnetic sensor 24 may have a memory, a logic controller, and a display. When initiated the logic controller 30 sends a command to the geomagnetic sensor 24 to take an initial geomagnetic field reading. The geomagnetic sensor then takes the initial geomagnetic field reading and sends it to memory 32. The logic controller 30 will continue, at predetermined intervals, to command the geomagnetic sensor 24 to take secondary geomagnetic field readings and send each secondary geomagnetic field reading to memory 32. The logic controller 30 will then access from memory 32 the initial geomagnetic field reading and the secondary geomagnetic field reading. If the secondary geomagnetic field reading and the initial geomagnetic field reading are similar or within predetermined bounds then the logic controller will send a 1^{st} message 34 indicating that the gate is open. However, if the secondary geomagnetic field reading and the initial geomagnetic field readings differ or are outside of predetermined bounds then the logic controller 30 will send a 2^{nd} message 36 that the gate is closed or at some position between clear and occupied or open or closed. In certain instances, the memory may contain a data set 33. The logic controller may then compare the first reading, as well as any additional readings to the data set 33 within the memory to determine whether the gate valve is fully open, fully closed, or in between. Additionally, in some instances the logic controller may also send a signal, such as valves operable 38, to any powered gate valve actuator allowing the gate valve to be closed or opened. The valve actuator may include the gate, the stem, or any appurtenance that moves in relation to the gate position. Or the logic controller may send a signal, such as valves inoperable 40. In certain instances, the geomagnetic sensor, the logic controller, the memory, and the display may be a single unit in a single housing and the display may simply be a light on or off, a colored light, a raised flag, or other signal. In other instances, the geomagnetic sensor may be connected by wire or radio to a separate logic controller and memory such as an app on a smart phone, smart pad, or computer. The radio connection is a wireless connection that includes bluetooth, wi-fi, cellular or other radio types. The display may be directly wired to the logic controller or may be connected by radio to the logic controller and may simply be a screen where an icon or other notification may be displayed.

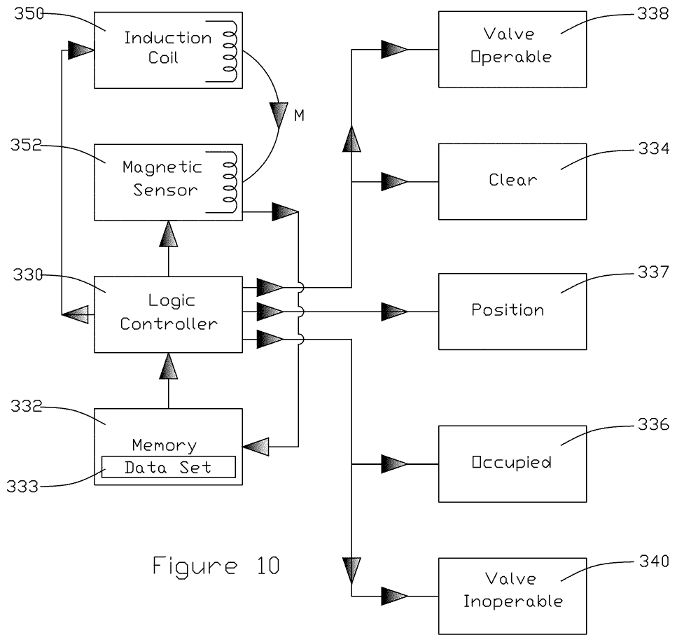

FIG. 10 is a block diagram depicting the operation of the induction coil, magnetic sensor, logic controller, memory, and display. The induction coil 350 may provide a continuous magnetic field, an intermittent magnetic field, or an on command magnetic field. The magnetic sensor 352 may include a memory 332, a logic controller 330, and a display. When initiated the logic controller 330 sends a command, if needed, to the induction coil 350 to create a magnetic field. The logic controller 330 also commands the magnetic sensor 352 to take an initial magnetic field reading. The magnetic sensor 352 takes the initial magnetic field reading and sends it to memory 332. The logic controller 330 will continue, at predetermined intervals, to command the induction coil 350 to create a magnetic field if necessary and also command the magnetic sensor 352 to take secondary magnetic field readings sending each secondary magnetic field reading to memory 332. The logic controller 330 will then access from memory 332 the initial magnetic field reading and the secondary magnetic field reading. If the secondary magnetic field reading and the initial magnetic field reading are similar or within predetermined bounds then the logic controller will send a 1^{st} message 334 indicating that the gate is open. However, if the secondary magnetic field reading and the initial magnetic field readings differ or are outside of predetermined bounds then the logic controller 330 may provide a message 336 that the gate is closed and at which position the gate is located 337 up to and including that the gate is fully closed. Additionally, in some instances the logic controller 330 may also send a signal, such as valves operable 338, that allows the gate valve to be actuated. In certain instances, the magnetic sensor 352, the logic controller 330, the memory 332, and the display may be a single unit. In certain instances, the memory may contain a data set 333. The logic controller may then compare the first reading, as well as any additional readings to the data set 333 within the memory to determine whether the gate valve is fully open, fully closed, or in between. The display may simply be a light on or off, a colored light, a raised flag, or other signal. In other instances, the geomagnetic sensor may be connected by wire or wireless to a separate logic controller and memory such as an app on a smart phone, smart pad, or computer. The display may simply be a screen where an icon or other notification may be displayed.

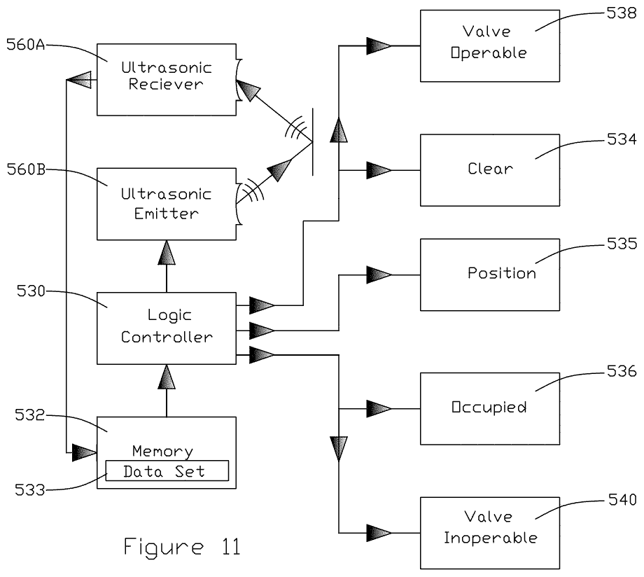

FIG. 11 is a block diagram depicting the operation of either ultrasonic transducer 560 or 570, a logic controller 530, a memory 532, and a display. The ultrasonic transducers 560 or 570 generally have an ultrasonic emitter 560B and an ultrasonic receiver 560A in the same housing however in some instances the ultrasonic receiver 560A may be in a different housing than the ultrasonic emitter 560B. In some instances the entire each sensor or unit including memory, logic controller, and display may be housed in the same unit. In any event, upon initiation or start the logic controller 530 sends a command, if needed, to the ultrasonic emitter 560B to send an initial ultrasonic pulse. The ultrasonic receiver 560A receives the initial ultrasonic pulse reflection or reflections and sends them to memory 532 to be recorded. The logic controller 530 will continue, at predetermined intervals, to command the ultrasonic emitter 560B to send secondary ultrasonic pulses. The secondary reflections of the secondary ultrasonic pulses are then recorded by ultrasonic receiver 560A and sent to memory 532. The logic controller 530 will then access from memory 532 the initial ultrasonic pulse reflection and the secondary ultrasonic pulse reflection. The logic controller will then determine the position 535 of the gate within the throughbore based upon the initial and secondary reflections. In certain instances, the memory may contain a data set 533. The logic controller may then compare the first reading, as well as any additional readings to the data set 533 within the memory to determine whether the gate valve is fully open, fully closed, or in between

In certain instances, the magnetic sensor 552, the logic controller 530, the memory 532, and the display may be a single unit. The display may simply be a light on or off, a colored light, a raised flag, or other signal. In other instances, the ultrasonic transducer 560 or 570 may be connected by wire or wireless to a separate logic controller and memory such as an app on a smart phone, smart pad, or computer. The display may simply be a screen where an icon or other notification may be displayed.

An initial reading of the geomagnetic field, magnetic field, or the ultrasonic pulse may each be taken when the gate is fully open. In certain instances, the initial reading may be taken with the gate fully closed with the second and tertiary readings compared to the gate closed readings. The logic controller will then adjust the display accordingly to show a closed gate when the gate is closed and to show an open gate when the gate is open.

The nomenclature of leading, trailing, forward, rear, clockwise, counterclockwise, right hand, left hand, upwards, and downwards are meant only to help describe aspects of the tool that interact with other portions of the tool.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A gate valve positioning system comprising;
a tubular having a throughbore affixed to a well,
a valve actuator within the tubular;
a sensor, a logic controller, and a memory;
wherein the logic controller commands the sensor to take a first reading of the valve actuator and the first reading is sent to the memory,
wherein the logic controller commands the sensor to take a second reading of the valve actuator and the second reading is sent to the memory,
further wherein the logic controller compares the first reading to the second reading.

2. The gate valve positioning system of claim 1 wherein, the geomagnetic sensor, the logic controller, and the memory are housed in a single housing.

3. The gate valve positioning system of claim 1 wherein, the geomagnetic sensor sends and receives information between the logic controller and memory by wires.

4. The gate valve positioning system of claim 1 wherein, the geomagnetic sensor sends and receives information between the logic controller and memory by radio.

5. The gate valve positioning system of claim 1 wherein, the logic controller is connected to a display.

6. The gate valve positioning system of claim 1 wherein, the logic controller is connected to a display via radio.

7. A gate valve positioning system comprising;
a tubular having a throughbore affixed to a well,
a valve actuator within the tubular;
a sensor, a logic controller, a memory, and a data set within memory;
wherein the logic controller commands the sensor to take a first reading of the valve actuator and the first reading is sent to the memory,
further wherein the logic controller compares the first reading to the data set.

8. The gate valve positioning system of claim 1 wherein, the geomagnetic sensor, the logic controller, and the memory are housed in a single housing.

9. The gate valve positioning system of claim 1 wherein, the geomagnetic sensor sends and receives information between the logic controller and memory by wires.

10. The gate valve positioning system of claim 1 wherein, the geomagnetic sensor sends and receives information between the logic controller and memory by radio.

11. The gate valve positioning system of claim 1 wherein, the logic controller is connected to a display.
The gate valve positioning system of claim 1 wherein, the logic controller is connected to a display via radio.
